(19) United States
(12) Patent Application Publication
(10) Pub. No.: US 2011/0036670 A1
(43) Pub. Date: Feb. 17, 2011

(54) LIFT GUIDE

(75) Inventor: Jesús Sanz Gamboa, Vera De Bidasoa (Navarra) (ES)

Correspondence Address: LUCAS & MERCANTI, LLP, 475 PARK AVENUE SOUTH, 15TH FLOOR, NEW YORK, NY, 10016, US

(73) Assignee: S.A. DE VERA (SAVERA), VERA DE BIDASOA (Navarra) (ES)

(21) Appl. No.: 12/989,847

(22) PCT Filed: May 28, 2009
(86) PCT No.: PCT/ES2009/000299

§ 371 Date: Oct. 27, 2010

(30) Foreign Application Priority Data
Jun. 6, 2008 (ES) P200801760

(51) Int. Cl. B66B 7/02

(52) U.S. Cl. 187/406

(57) ABSTRACT

The invention relates to a lift guide with a symmetry axis OY, consisting of a mushroom-shaped element (1) and two flanges (2), each side of the mushroom element (1) being provided with a side braking and guiding surface for the lift-braking and -guiding elements (fg). The invention is characterised in that the mushroom element (1) includes a head (3) which prevents the braking and/or guiding elements (fg) from moving along the axis.

The head (3) of the mushroom element (1) has: two side braking and/or rolling surfaces (3′, 3″), on either side of the symmetry axis, which converge toward one another in the direction of the interior or exterior of the mushroom element (1); and larger dimensions along the OX axis than the side braking/guiding surfaces (3′, 3″).

The object of the invention is a new lift guide.

An unresolved problem present in current (known) lift guides is that of safety, particularly with regard to preventing the guides from coming out of the cabin and the counterweight and maintaining the overspeed brakes, when they operate, inside the guides.

This problem is accentuated, for example, in seismic zones, which are very critical with regard to the derailing of the lift and especially to of the counterweight which, due to the accelerations caused when earthquakes occur, come off the guides and strike against the cabin.

The new lift guide, according to the invention, limits movements in two directions, while the current (known) guides only limit it in one direction. For this purpose, the lift guide, according to the invention, being of the type made with a symmetry axis O̅Y̅ and which consists of a mushroom element and two flanges, each side of the mushroom element being provided with a side braking and guiding surface for the braking and guiding elements of the lift; it is characterized in that the mushroom element consists of a head which prevents the movement of the braking and/or guiding elements along the O̅Y̅ axis.

The following is included in the new lift guide that is the object of the invention:
The mushroom-button head has, on each side of the symmetry axis O̅Y̅, two side braking and/or rolling surfaces converging toward one other, in the direction of the interior or the exterior of the mushroom element.
At least one of the side surfaces is curved, and
The head has larger dimensions along the O̅X̅ axis than the side braking/guiding surfaces.

Other additional advantages of the lift guides according to the invention are deduced from the description and figures represented in the attached diagrams in which:

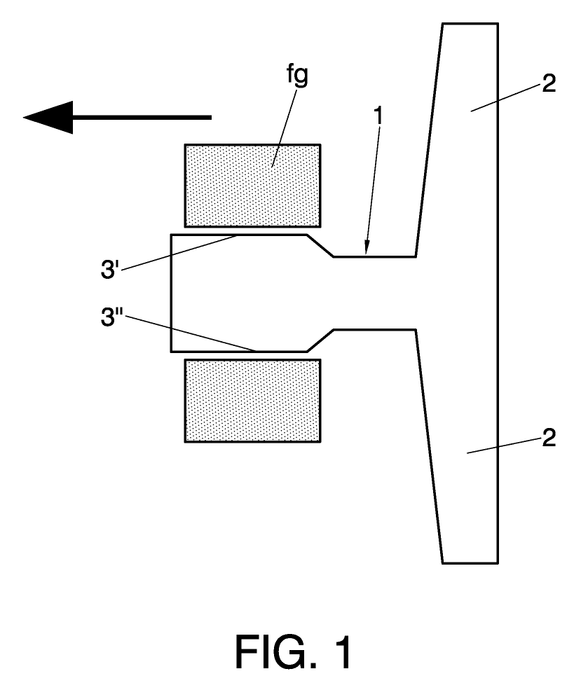

FIG. 1 represents a general cross-section of the known lift guides.

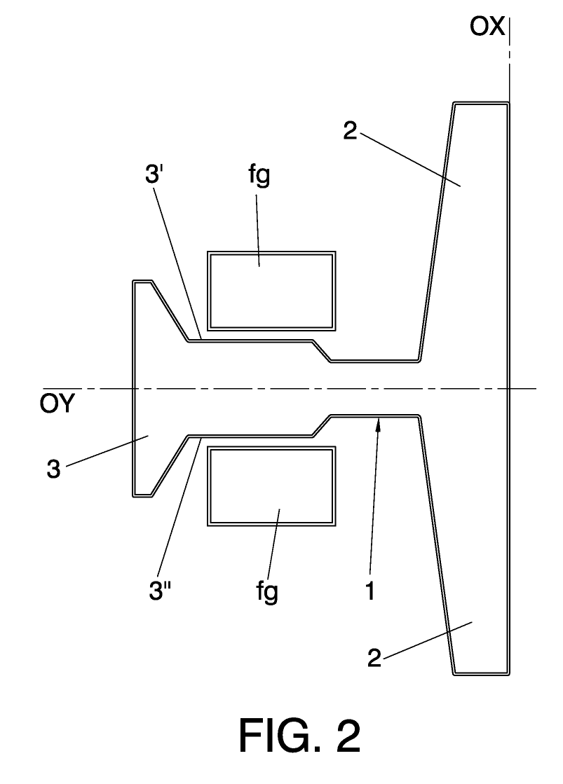

FIG. 2 represents a general cross-section of the lift guides, according to the invention.

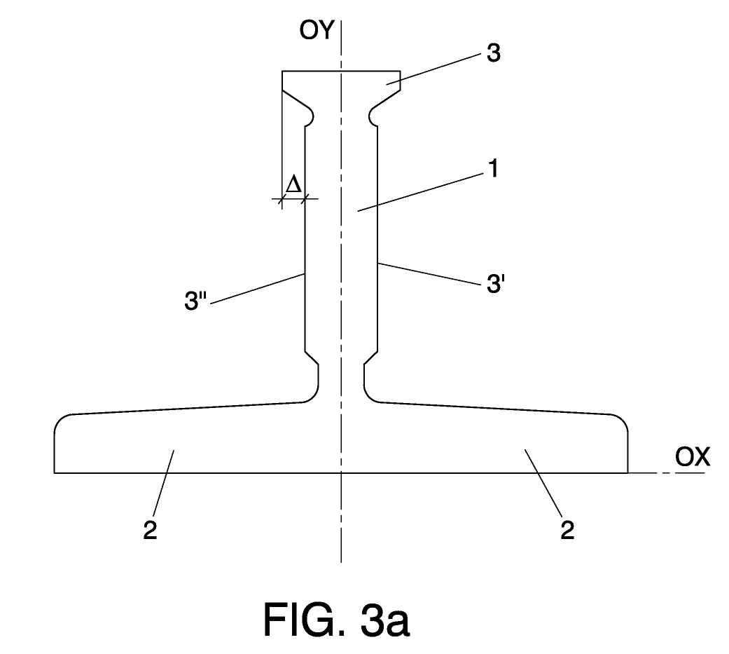

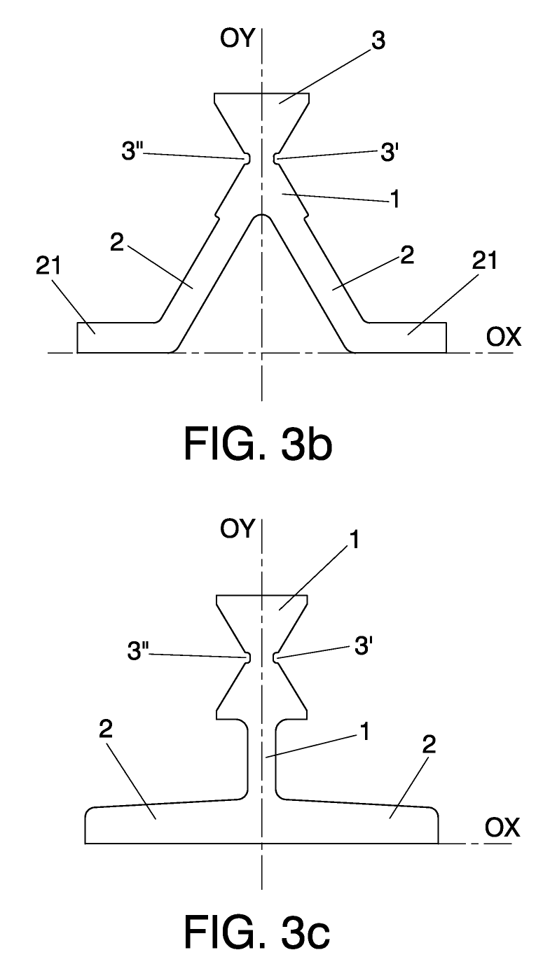

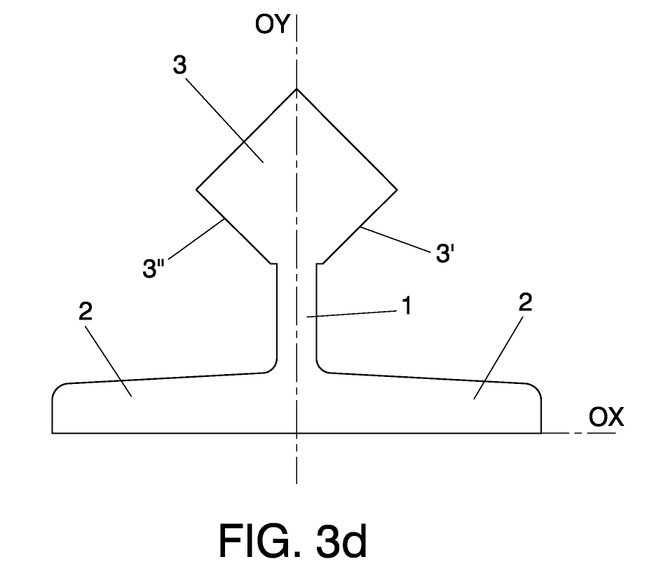

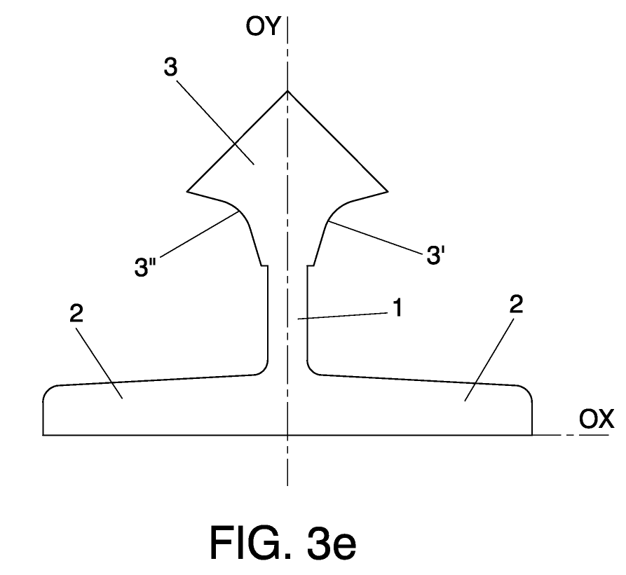

FIGS. 3a to 3e schematically represent general cross-sections of lift guides according to the invention similar to FIG. 2 and for practical alternative embodiments.

An example of practical, non-limiting embodiment of this invention is described as follows:

The lift guide, according to the invention, is of the type made up of a symmetry axis O̅Y̅ and which consists of mushroom core (1) and side flanges (2); each side of the mushroom element (1) being provided with a side braking and guiding surface (3′), (3″) for the braking and guiding elements (fg) of the lift.

According to the invention—see FIG. 2—, the mushroom element (1) consists of a head (3) that prevents the movement of the braking and/or guiding elements (fg) along the O̅Y̅ axis. It is basic for the purposes of the invention that said head (3)—see FIG. 3a—should have larger dimensions (Δ) along the O̅X̅ axis than the side braking/guiding surfaces (3′), (3″).

Based on this basic concept, any practical alternative embodiments of guides that do not essentially alter, change or modify the proposal are interchangeable and are included in the object of the invention.

According to the embodiment represented in FIG. 3a, the mushroom element (1) defines in itself the side braking and guiding surfaces (3′), (3″) for the braking and guiding elements (fg) of the lift.

According to the embodiment represented in FIG. 3b, the mushroom element (1) and the head (3) define, in their conjunction, the to side braking and guiding surfaces (3′), (3″) for the braking and guiding elements (fg) of the life. The flanges (2) are not coplanar, but rather oblique with respect to each other and have end support projections (21).

According to the embodiments represented in FIGS. 3c and 3d, the side braking and guiding surfaces (3′), (3″) for the braking and guiding elements (fg) of the lift are defined on the head itself (3): some in concavity—FIG. 3c—and others in convexity—FIG. 3d—.

In the embodiments represented, the side braking and guiding surfaces (3′), (3″) for the braking and guiding elements (fg) of the lift, irrespectively of whether they are defined in the mushroom element (1) or in the head (3) are straight. In the lift guide, according to the invention, it is also indicated that said side surfaces will be curved (concave—as in FIG. 3e—or convex) without essentially altering the invention as a result.

1. A lift guide, with a symmetry axis O̅Y̅ that consists of a mushroom element (1) and two flanges (2), each side of the mushroom element (1) being provided with a side braking and guiding surface for the braking and guiding elements (fg) of the lift; it is characterized in that the mushroom element (1) consists of a head (3) that prevents the movement of the braking and/or guiding elements (fg) along the O̅Y̅ axis.

2. A lift guide, according to claim 1, characterized in that the head (3) of the mushroom element (1) has, on each side of the symmetry axis O̅Y̅, two side braking and/or rolling surfaces (3′), (3″) converging toward one another in the direction of the interior or the exterior of the mushroom element (1).

3. A lift guide, according to claim 2, characterized in that at least one of said side surfaces (3′), (3″) is curved.

4. A lift guide, according to claim 1, characterized because the head (3) has larger dimensions along the O̅X̅ axis than the side braking/guiding surfaces (3′), (3″).
